(19) United States
(12) Patent Application Publication
(10) Pub. No.: US 2011/0244775 A1
(43) Pub. Date: Oct. 6, 2011

(54) APPARATUS AND METHOD FOR CONTROLLING AND DIRECTING FLOW OF CONTAMINATED AIR TO FILTERS AND FOR MONITORING FILTER LOADING IN A BIOLOGICAL SAFETY CABINET

(75) Inventors: Robert Kenneth Haugen, Statesville, NC (US); Kurt P. Rindoks, Davidson, NC (US); Arturo Ramos, Statesville, NC (US)

(73) Assignee: Kewaunee Scientific Corporation, Statesville, NC (US)

(21) Appl. No.: 12/753,420

(22) Filed: Apr. 2, 2010

(51) Int. Cl. B08B 15/02; F24F 7/007; F24F 13/08; B01D 50/00; B01D 46/00; B01D 46/44; G01F 1/34

(52) U.S. Cl. 454/61; 454/230; 454/284; 96/421; 55/339; 95/284; 73/861.42

(57) ABSTRACT

An improved system and method for monitoring contamination loading of a filter in a biological safety cabinet comprising a housing defining a work chamber and a filtration chamber, a system for circulating air between the work chamber and the filtration chamber via a fan which draws air under negative pressure from the work chamber and delivers the air under positive pressure through the filter and into the filtration chamber. The filter monitoring system determines a pressure differential between the negative and positive air pressure at opposite sides of the fan, and evaluates the degree of contamination loading of the filter on the basis of the pressure differential. An air flow baffle is disposed within the filtration chamber adjacent the fan for dividing the pressurized air delivered by the fan and partially redirecting a portion thereof for more uniformly delivering the air to the filter.

### BACKGROUND OF THE INVENTION

The present invention relates generally to biological safety cabinets and, more particularly, to means and methods for the recirculation and filtration of the flow of potentially contaminated air within biological safety cabinets.

Biological safety cabinets provide a biohazard containment means which enable laboratory personnel in diverse industries, e.g., life science, medical, and pharmaceutical industries, to perform various laboratory, experimental and like procedures utilizing biologically hazardous substances while protecting the personnel, the work product and the ambient environment from exposure to and contamination by such substances. Biological safety cabinets are currently certified by the National Sanitation Foundation (NSF) International, of Ann Arbor, Mich., according to three levels of classification. The present invention is particularly applicable to the class of biological safety cabinets referred to as Class II, Type A2 cabinets.

Class II A2 biological safety cabinets basically have a work chamber that is mostly enclosed except for a front access opening sufficient for a user's hands to perform procedures within the work chamber. An air circulation system maintains a continuously circulating positive air flow within the work chamber which is controlled to move laminarly in parallel relation to the front access opening to prevent escape of the internal cabinet air outwardly through the forward access opening to protect the user and the ambient area from contamination. The air circulation system utilizes a fan to continuously withdraw air from the work chamber into an adjacent filtration chamber from which a portion of the air is recirculated into the work chamber through a first high efficiency particulate air filter, commonly referred to as a HEPA filter, while the balance of the withdrawn air is exhausted outside the cabinet through a second HEPA filter. Typically, a ratio of about 70% recirculated air to 30% exhausted air is maintained in Class II A2 cabinets. The exhausted air is replaced by ambient air from the surrounding room drawn first into the filtration chamber before entering the work chamber through the first filter, thereby to prevent room air contamination of the work chamber and also to maintain the integrity of the laminar air flow along the front access opening.

It is important that the filters in such biological safety cabinets be replaced with sufficient frequency to maintain uniformity in the laminar velocity of the circulating air and to minimize airborne contaminants in the circulating air. In turn, therefore, it is important that personnel monitor the degree of loading of the filters with contaminants to be alerted to replace the filters when reaching or approaching a predetermined full condition. This maintenance requirement poses particular safety issues in that a visual or other manual inspection of the filters is not possible due to the contaminated nature of the air circulating within the filtration chamber.

Thus, conventional biological safety cabinets typically include a means of remote detection of the load condition of the filters, usually by the monitoring of a variable performance parameter of the cabinet deemed to be indicative of the degree of loading of the filters. For example, one known prior art safety cabinet measures the ongoing electrical load on the motor driving the air circulation fan on the premise that progressive loading of the filters places an increasing measurable burden on the fan motor to continue driving the fan at a desired speed. A disadvantage of such a system is that a DC (direct current) fan motor must be used in order to measure changes in the motor load. Also, a complex algorithm may be required to accurately extrapolate a measure of filter loading based on fan motor load. Another known biological safety cabinet uses a tube penetrating through the exterior cabinet wall into the air circulation area to measure changes in static air pressure as an indicator of progressive filter loading, but such systems pose the risk of the escape of contaminants into the ambient area surrounding the cabinet through the penetration opening in the cabinet and require careful secure sealing of such opening as well as additional filtration of the internal cabinet air that enters the tube.

Hence, there is a continuing need in the industry for a simple yet reliable means of tracking the degree of progressive loading of HEPA filters in biological safety cabinets over an ongoing period of operation without complex electronics or software, without eliminating the option of utilizing AC (Alternating current) fan motors, and without the risk of escape of contaminated air from the cabinet.

A related issue in the design and operation of biological safety cabinets is the objective of achieving uniform loading of the filters across the full surface area of the filters. Uniform collection of contaminants across the face of each filter promotes uniformity in the air flow through the filter and, in turn, within the work chamber of the cabinet. Conversely, excessive non-uniform build-up of contaminants in one or more surface regions of a filter may cause turbulence in the flow of air through the filter and downstream within the work chamber, which may interfere with the desired laminar flow of air through the work chamber. The overall size of biological safety cabinets is a contributing factor to this issue in that the desire for compactness in the exterior cabinet dimensions tends to result in cabinet designs with less linear and more circuitous air flow pathways into and through the filtration chamber. In turn, conventional cabinet designs tend to be unable to present the filtration airflow uniformly across the face of the filters, which tends to result in uneven accumulation of contaminants across the filters. One manner of addressing this issue in conventional biological safety cabinets is to provide an air flow baffle within the filtration chamber adjacent the fan for dividing the pressurized air delivered by the fan and partially redirect a portion thereof for more uniformly delivering the air to the filter. While such baffles are nominally effective to improve the overall distribution of the contaminated air flow across the filters, there continues to exist air turbulence and significant differences in static pressure within different regions of the filtration chamber and there is also the disadvantage that the baffles tend to increase noise from the pressurized air flow traveling along the baffle.

Accordingly, there is also a need within the industry for a further improved means for promoting uniform loading of filters across the full lengthwise and widthwise extent of the filter face, to promote uniformity in air flow, minimize turbulence and noise, and achieve uniform filter loading and optimal filter life.

### SUMMARY OF THE INVENTION

The present invention seeks to address the foregoing needs of the industry by providing an improved system and method for monitoring contamination loading of a filter in a biological safety cabinet of the general type comprising a housing defining a work chamber and a filtration chamber, and an air recirculation system for circulating air between the work chamber and the filtration chamber via a fan interposed between the work chamber and the filtration chamber to draw air under negative pressure from the work chamber and deliver the air under positive pressure through the filter and into the filtration chamber. According to the present invention, the filter monitoring system comprises a sensor arrangement for determining a pressure differential between the negative air pressure entering the fan and the positive air pressure in the filtration chamber on the opposite side of the fan, and an evaluation device associated with the sensor arrangement for determining contamination loading of the filter in relation to the pressure differential. Basically, the negative air pressure entering the fan is sensed, the positive air pressure in the filtration chamber on the opposite side of the fan is also sensed, a pressure differential between the sensed negative and positive pressure is determined, and the degree of contamination loading of the filter is evaluated on the basis of the pressure differential.

The sensor arrangement may advantageously comprise a pressure transducer which produces a varying output voltage according to the pressure differential and delivers the output voltage to the evaluation device. The pressure transducer may include a sensor input from adjacent an air intake region of the fan for sensing the negative air pressure entering the fan and a sensor input from the filtration chamber for sensing the positive air pressure in the filtration chamber on the opposite side of the fan. In a preferred embodiment, the pressure transducer is disposed on the negative pressure side of the fan, and the evaluation device is disposed outside the air recirculation system and connects with the pressure transducer only by electrical wires extending sealably through the housing. The evaluation device preferably utilizes logic for computing a quantitative value representative of the contamination loading of the filter as a function of changes sensed in the pressure differential over a time period of use of the filter.

According to another aspect of the invention, an air flow baffle may be disposed within the filtration chamber adjacent the fan for dividing the pressurized air delivered by the fan and partially redirecting a portion thereof for more uniformly delivering the air to the filter. The baffle comprises a generally planar flange disposed at an obtuse angle to a leading end of the baffle facing the fan and oriented generally in parallel relation to the direction of pressurized air flow from the fan, with a curvilinear main baffle body connected angularly to and extending away from the flange. Preferably, the curvilinear main baffle body comprises a first generally linear section connected at the obtuse angle to the flange, a generally curved section extending reversely from the linear section, and a second generally linear section extending from the curved section. The obtuse angle at which the flange and the linear section of the baffle body are connected is not considered to be critical, but preferably is between about 135 degrees and about 155 degrees, and may for example be approximately 146 degrees. A second air flow baffle may also be disposed within a distal region of the filtration chamber at a spacing from the fan for supplemental direction of a portion of the pressurized air delivered by the fan into the distal region of the filtration chamber.

A second filter may be provided between the filtration chamber and an exhaust opening in the housing for exhausting a portion of the pressurized air delivered by the fan to outside the housing. Preferably, the first-mentioned baffle and the second baffle cooperatively direct a portion of the pressurized air delivered by the fan to the first-mentioned filter and another portion of the pressurized air to the second filter.

### BRIEF DESCRIPTION OF THE DRAWINGS

FIG. 1 is a partially exploded and partially broken-away perspective view of a biological safety cabinet according to a preferred embodiment of the present invention;

FIG. 2 is a vertical cross-sectional view of the biological safety cabinet of FIG. 1, taken along line 2-2 thereof;

FIG. 3 is another vertical cross-sectional view of the biological safety cabinet of FIG. 1, taken along line 3-3 thereof; and

FIG. 4 is a schematic diagram depicting the sensor and evaluation arrangement of the biological safety cabinet for monitoring contamination loading of the filter.

### DETAILED DESCRIPTION OF THE PREFERRED EMBODIMENTS

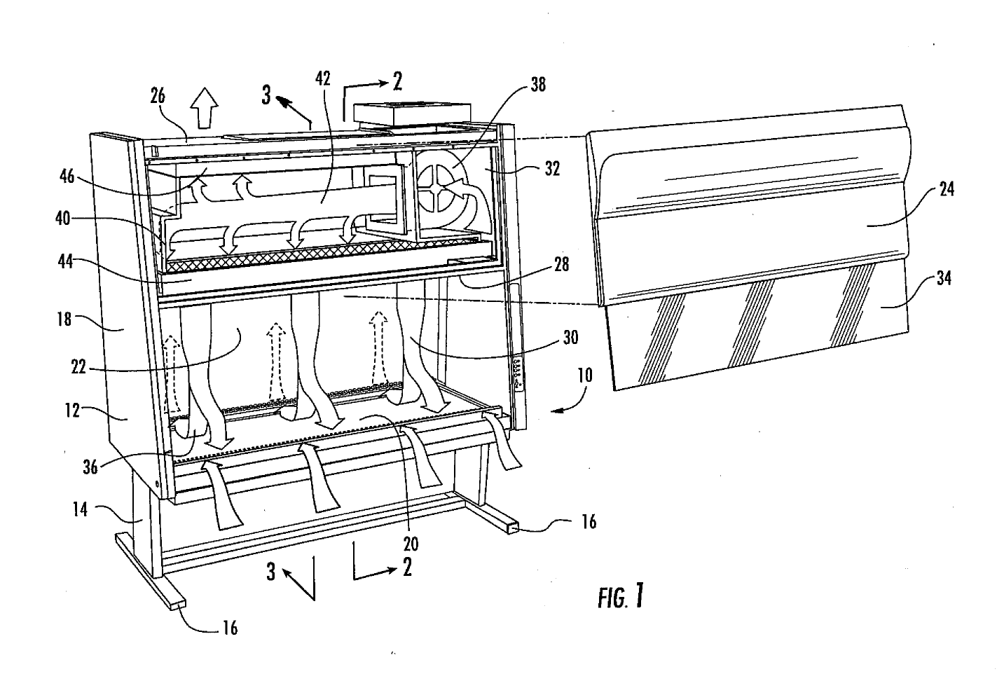

Referring now to the accompanying drawings, and initially to FIG. 1, a biological safety cabinet in accordance with one preferred embodiment of the present invention is indicated generally at 10. The safety cabinet 10 basically comprises a housing 12 supported on a trestle stand 14, which may include a set of casters 16 for movability of the cabinet structure. The housing 12 is a generally rectangular structure having spaced-apart end walls 18, a bottom wall 20, a rear wall 22, a partial front wall 24, and a top wall 26, collectively defining an open interior which is divided by a horizontal intermediate wall 28 into a lower work chamber 30 and an upper air recirculation chamber 32. The housing 12 may preferably be fabricated of sheet metal, such as stainless steel.

The partial front wall 24 predominately encloses only the air recirculation chamber 32, leaving open front access by users into the work chamber 30. A transparent sash 34 is supported by and extends downwardly from the front wall 24 to partially enclose the work chamber 30 except for a narrow front access opening 36 into the work chamber 30 between the bottom wall 20 and the lower edge of the sash 34 through which users may have manual access into the work chamber 30. The transparency of the sash 34 permits visual access into the work chamber 30 by users. The sash 34 may also be retractable as necessary to permit greater access into the work chamber 30 by users.

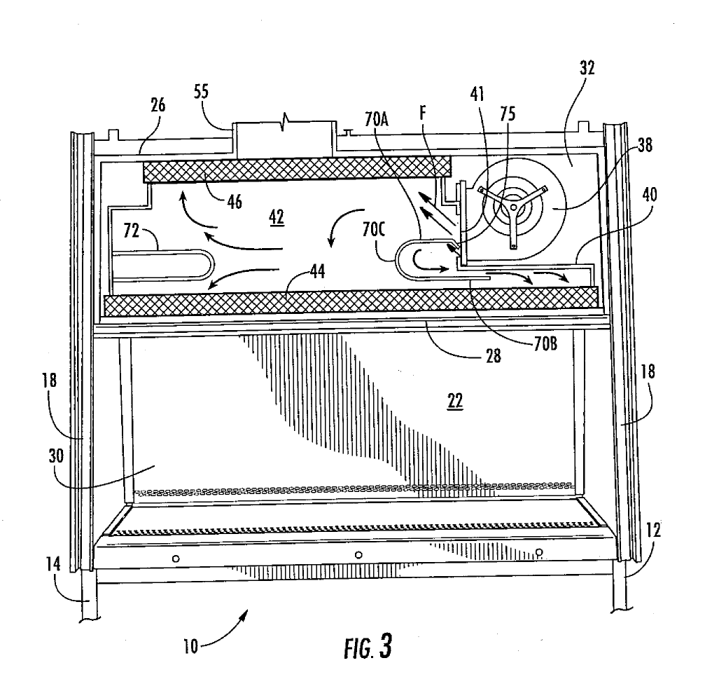

In FIG. 1, the front wall 24 is shown in exploded relation to the remainder of the cabinet 10 for illustration of the air recirculation chamber 32. As shown in FIG. 1 and further seen in FIG. 3, the majority of the air recirculation chamber 32 is occupied by a hollow sub-housing 40 the open interior of which serves as an air filtration chamber 42. An air circulation fan 38 is mounted within one end of the recirculation chamber 32 with the output side of the fan 38 mounted to one end of the sub-housing 40 to discharge blown air under positive pressurize into the air filtration chamber 42. The lowermost bottom side of the sub-housing 40 is open with a first air filter 44 affixed to the sub-housing in covering relation to the opening. Similarly, the uppermost topside of the sub-housing 40 is open with a second air filter 46 affixed to the sub-housing in covering relation to the opening. The two air filters 44, 46 are preferably high efficiency particulate air filters, more commonly referred to as HEPA filters, for their ability to capture molecular-sized microorganisms and like biological matter.

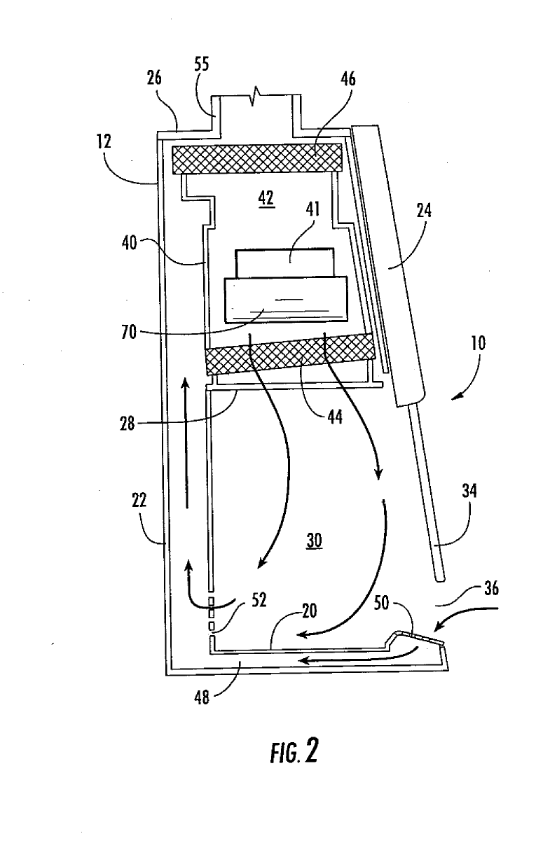

The intake side of the fan 38 draws air from within the work chamber 30 and also from the ambient air surrounding the safety cabinet 10 through hollow interior channels defined within the bottom and rear walls 20, 22 of the housing 12. More specifically, as best seen in FIG. 2, each of the bottom and rear walls 20, 22 are formed by dual spaced wall panels defining a continuous interior airflow channel 48 within the bottom wall 20 and continuing upwardly within the rear wall 22 to open into the air recirculation chamber 32. A series of perforations 50 are formed along substantially the full length of the forward edge of the bottom wall 20 to open into the forwardmost end of the airflow channel 48. A similar series of perforations 52 are formed along the lowermost end of the rear wall 22 adjacent its juncture with the bottom wall 20, also opening into the airflow channel 48 thereat.

The housing 12 of the safety cabinet 10 will thus be understood to provide a controlled air recirculation system which operates as follows. The fan 38 continuously creates a negative pressure condition within its end of the air recirculation chamber 32 which acts through the airflow channel 48 to draw air from within the work chamber 30 through the perforations 52 and into the airflow channel 48. To a somewhat lesser extent, surrounding ambient air is drawn into the airflow channel 48 through the perforations 50. The fan 38 pressurizes the in-drawn air and discharges it under positive pressure into the filtration chamber 42 from which a portion of the air passes downwardly through the filter 44 into the work chamber and a portion of the air passes upwardly through the filter 46 into an exhaust duct 55. The filter 44 is of a substantially larger size than the filter 46 such that the majority of the airflow, preferably approximately 70%, returns into the work chamber 30 through the filter 44, with only a smaller proportion, preferably approximately 30%, of the airflow being exhausted. Within the work chamber 30, the air passing downwardly through the filter 44 moves predominantly vertically downwardly in a laminar manner which, together with the constraint of the sash 34, the constraint of incoming ambient air into the perforations 50, and the negative pressure exerted from the fan through the rearward perforations 52, substantially prevents the escape of any of the airflow outwardly through the access opening 36. Thus, users may perform laboratory procedures within the work chamber 30 utilizing hazardous substances, e.g., microorganisms, particulate toxic chemicals, etc., without risking escape of such substances into the ambient area outside the cabinet. Moreover, as such procedures are ongoing, the continuous recirculation of the air internally within the housing 12 progressively filters airborne contaminants so as to maintain sufficient cleanliness within the internal air to prevent contamination of the procedure.

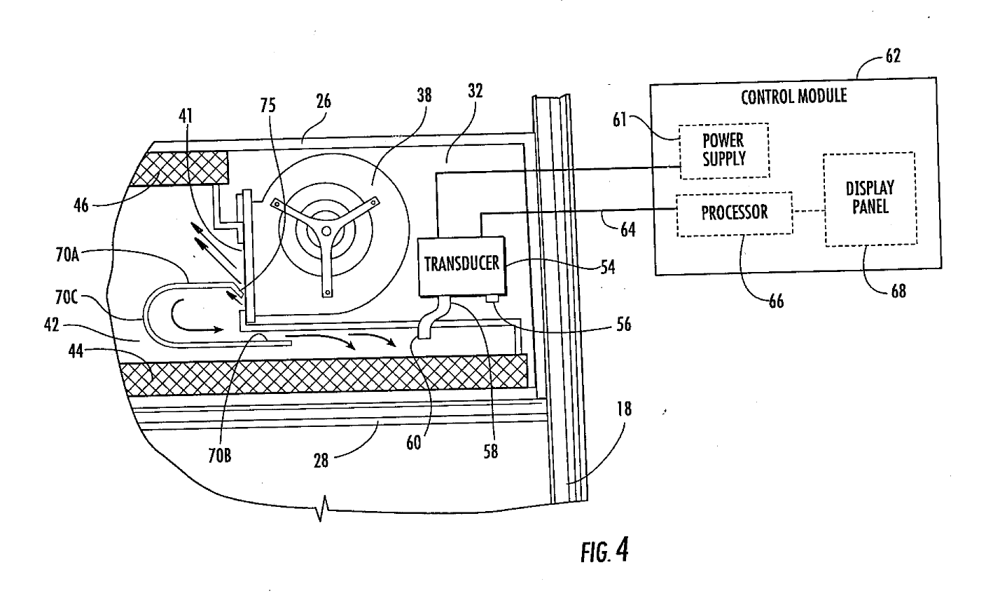

To the extent thus far described, the basic structure and operation of the biological safety cabinet 10 is essentially conventional. As will be understood, the filters 44, 46 will progressively become loaded with filtered contaminants over time as the cabinet is operated and, as described above, it is important to monitor the degree of filter loading so that the filters may be replaced on a periodic basis. The present invention provides a uniquely simple and reliable means of monitoring the contamination loading of the filters 44, 46 without the risks and disadvantages of the prior art. As depicted in FIG. 4, a pressure transducer 54 is positioned within the air recirculation chamber 32 on the intake side of the fan 38. The pressure transducer 54 is supplied with operating electrical power from a power supply 61 within a control module 62, each shown only schematically. The transducer 54 has a first input sensor 56 which is thereby exposed to and senses the prevailing negative pressure within the recirculation chamber 32. The transducer 54 also has a second input sensor 58 which is connected via a tube 60 through a wall of the sub-housing 40 to be similarly exposed to and to sense the prevailing positive pressure within the filtration chamber 42. An output connection 64 extends from the transducer 54 back to the control module 62. The transducer 54 is operative to transmit via the output 64 a variable output voltage proportionate to and thereby representative of the differential in pressure between the negative and positive prevailing pressures sensed by the input sensors 56, 58.

As will be understood, as the filters 44, 46 become progressively loaded with contaminants, the filters impose a greater resistance to airflow through the filters and, in turn, prevailing positive air pressure within the filtration chamber 42 will increase in proportion to the degree of filter loading. On the other hand, the prevailing negative pressure within the air recirculation chamber 32 is essentially unaffected by the loading of the filters. Thus, the overall pressure differential detected by the transducer 54 is proportionally representative of the degree to which the filters are loaded. In turn, monitoring of the progressively increasing pressure differential from the time new clean filters 44, 46 are installed is indicative of the progressive loading of the filters. Accordingly, the control module 62 is equipped with a processor, indicated only schematically at 66, which has a memory and stores operating program logic for computing a quantitative value representative of the contamination loading of the filters 44, 46 as a function of changes sensed in the pressure differential over a time period of use of the filters 44, 46. The processor 66 is connected to a display panel, indicated only schematically at 68, and is operative to display a visual representation of the quantitative value, e.g., as a digital numerical percentage value or in a graphical image display such as a dial or graph, or a combination thereof, enabling the user to constantly monitor the progressive loading of the filters.

Advantageously, the transducer 54 is completely contained within the air recirculation chamber 32, except only for the electrical wires providing the power supply to the transducer and the transducer output signals back to the control module. While it is necessary to seal the electrical wires at the location at which they extend through the housing 12, this is a substantially easier and more simple seal to accomplish than an air transmission tube penetrating through the housing as in prior art systems. While the tube 60 from the transducer 54 penetrates a wall of the filtration chamber 42, the sealing of such tube is not critical as the air in both the air recirculation chamber 32 and the filtration chamber 42 is equally contaminated. The use of the transducer 54 offers the advantages of easier and more reliable measurement of pressure differential than prior art systems which measure the voltage load on a fan motor. Also, the transducer 54 is easy to calibrate for the measurement of pressure differential, and can be utilized in conjunction with a fan driven by either an alternating current or direct current fan motor.

As previously noted, it is equally important to promote uniformity in the loading of the filters 44, 46 across their full lengthwise and widthwise extent. In the cabinet 10, the sub-housing 40 which defines the filtration chamber 42 is of a generally L-shaped configuration, as shown in FIGS. 1 and 3, which provides for mounting of the fan 38 and the sub-housing 40 within the same overall three-dimensional rectangular space above the work chamber 30 and also provides for the mounting of the differently sized filters 44, 46. Accordingly, the fan 38 directs its pressurized air discharge horizontally into the filtration chamber 42 from which the air must flow partially upwardly and partially downwardly through the respective filters 44, 46. As a result, there is a tendency for the airflow within the filtration chamber 42 to become more stagnant within the elongated portion of the chamber 42 beneath the fan 38. Likewise, a lesser volume of the airflow tends to reach the portions of the filters 44, 46 at the distal regions of the filtration chamber 42 spaced the greatest distance from the fan 38, and the air in such area can also become stagnant or turbulent.

The present invention provides an improved baffle arrangement within the filtration chamber 42 for more efficiently controlling the movement and flow of contaminated air within the filtration chamber 42 so as to present the airflow uniformly across the face of each filter. More specifically, as best seen in FIG. 3, an arrangement of baffles 70, 72 is provided within the filtration chamber 42 to assist in channeling the incoming pressurized airflow from the fan 38 to the more remote regions of each filter 44, 46. The baffle 70 is mounted to the interior wall surface of the sub-housing 40 at the fan discharge opening 41 therein and has a main body which is of an overall curvilinear configuration comprised of two generally planar leg sections 70A, 70B connected by a curving intermediate connecting section 70C forming a generally parabolic-like shape. The upper leg section 70A of the baffle 70 is positioned immediately adjacent the fan discharge opening 41.

In contrast to known forms of air flow baffles in conventional biological safety cabinets, the baffle 70 further includes a short planar flange 75 projecting angularly from the leading end of the leg section 70A immediately adjacent the fan discharge opening 41. The angle between the flange 75 and the leg section 70A is an obtuse angle preferably in the range of about 135 degrees to about 155 degrees (i.e., the flange is bent at an acute angle to the plane of the leg section 70A between approximately 25 degrees and approximately 45 degrees). In the illustrated embodiment, the obtuse angle is substantially 146 degrees (i.e., essentially 34 degrees to the plane of the leg section 70A) which has been found to provide advantageous results, as described more fully hereinafter. The baffle 70 is disposed with the flange 75 oriented essentially parallel to the direction of the discharged airflow from the fan 38, which is slightly upwardly within the filtration chamber as represented by directional arrows F in FIG. 3. The leg section 70A in turn extends from the flange 75 at a slightly downward angle relative to the air flow discharge of the fan 38, and therefrom the connecting section 70C and the lower leg section 70B extend reversely into the narrow extent of the sub-housing 40 beneath the fan 38.

In this manner, the baffle 70 is effective to partially divide the air stream discharged from the fan 38, causing the divided portion of the air stream to follow a reversed flow path into the narrow extent of the sub-housing 40 while permitting a portion of the discharged air stream to continue horizontally into the filtration chamber 42. However, in contrast to known baffles, the flange 75 together with the orientation of the main baffle body at an obtuse angle to the flange 75 dramatically reduces the static pressure drop in the air flow moving within the baffle 70, commensurately reduces any stagnation or turbulence in the airflow within the baffle and in the adjacent regions of the filtration chamber 42, and significantly mitigates air flow noise thusly generated. In turn, the adjacent portions of the filter 44 receive a proportionate portion of the incoming air stream to promote uniform loading of the filter 44 across its full widthwise and lengthwise extent.

The baffle 72 is mounted to the vertical wall of the sub-housing 40 most distally opposite the fan 38 and is of a symmetrically parabolic shape which assists in dividing the airflow reaching the distal region of the filtration chamber 42 to redirect a portion of the airflow upwardly toward the distal end of the filter 46 and another portion of the airflow downwardly toward the distal end of the filter 44. In this manner, the baffle 72 similarly tends to mitigate any tendency of the air within the distal end of the filtration chamber 42 to stagnate or become turbulent, thereby also assisting in maintaining flow of the incoming air to the filters 44, 46.

The two baffles 70, 72 thus cooperate in promoting a uniform movement and presentation of the airflow to each filter 44, 46 essentially across the full lengthwise and widthwise extent of each filter for more uniform loading of the filters with contaminants. In turn, excessive localized accumulation of filter contaminants is mitigated to better optimize the filtration capacity and overall life of each filter. In addition, the uniform presentation of airflow across the length and width of the filter 44 promotes the desired laminar flow of air downwardly within the work chamber 30 substantially over its full lengthwise and widthwise extent to assist in optimizing the intended operative flow of air within the work chamber 30. The baffles 70, 72 also tend to reduce the noise generated by turbulence in the airflow within the filtration chamber 42.

It will therefore be readily understood by those persons skilled in the art that the present invention is susceptible of a broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A biological safety cabinet comprising:
(a) a housing defining a work chamber and a filtration chamber,
(b) an air recirculation system for circulating air between the work chamber and the filtration chamber, the air recirculation system including
(i) a fan interposed between the work chamber and the filtration chamber for drawing air under negative pressure from the work chamber and delivering the air under positive pressure into the filtration chamber, and
(ii) a filter between the filtration chamber and the work chamber for removing contaminants from the air before re-entering the work chamber, and
(c) a system for monitoring contamination loading of the filter comprising
(i) a sensor arrangement for determining a pressure differential between the negative air pressure entering the fan and the positive air pressure in the filtration chamber on the opposite side of the fan, and
(ii) an evaluation device associated with the sensor arrangement for determining contamination loading of the filter in relation to the pressure differential.

2. A biological safety cabinet according to claim 1, wherein the sensor arrangement comprises a pressure transducer.

3. A biological safety cabinet according to claim 2, wherein the pressure transducer produces an output voltage which varies according to the pressure differential.

4. A biological safety cabinet according to claim 3, wherein the output voltage is delivered to the evaluation device.

5. A biological safety cabinet according to claim 3, wherein the pressure transducer includes a sensor input from adjacent an air intake region of the fan for sensing the negative air pressure entering the fan and a sensor input from the filtration chamber for sensing the positive air pressure in the filtration chamber on the opposite side of the fan.

6. A biological safety cabinet according to claim 3, wherein the pressure transducer is disposed on the negative pressure side of the fan.

7. A biological safety cabinet according to claim 2, wherein the evaluation device is disposed outside the air recirculation system and connects with the pressure transducer only by electrical wires extending sealably through the housing.

8. A biological safety cabinet according to claim 1, wherein the evaluation device comprises logic for computing a quantitative value representative of the contamination loading of the filter as a function of changes sensed in the pressure differential over a time period of use of the filter.

9. A biological safety cabinet according to claim 1, further comprising an air flow baffle disposed within the filtration chamber adjacent the fan for dividing the pressurized air delivered by the fan and partially redirecting a portion thereof for more uniformly delivering the air to the filter.

10. A biological safety cabinet according to claim 9, wherein the baffle comprises a generally planar flange disposed at a leading end of the baffle facing the fan and oriented substantially in parallel relation to the direction of pressurized air flow from the fan and a curvilinear main baffle body connected angularly to and extending away from the flange.

11. A biological safety cabinet according to claim 9, further comprising a second air flow baffle disposed within a distal region of the filtration chamber at a spacing from the fan for supplemental direction of a portion of the pressurized air delivered by the fan into the distal region of the filtration chamber.

12. A biological safety cabinet according to claim 11, further comprising a second filter between the filtration chamber and an exhaust opening in the housing for exhausting a portion of the pressurized air delivered by the fan to outside the housing.

13. A biological safety cabinet according to claim 12, wherein the first-mentioned baffle and the second baffle cooperatively direct a portion of the pressurized air delivered by the fan to the first-mentioned filter and another portion of the pressurized air to the second filter.

14. A biological safety cabinet according to claim 1, further comprising a second filter between the filtration chamber and an exhaust opening in the housing for exhausting a portion of the pressurized air delivered by the fan to outside the housing.

15. A biological safety cabinet comprising:
(a) a housing defining a work chamber and a filtration chamber, and
(b) an air recirculation system for circulating air between the work chamber and the filtration chamber, the air recirculation system including
(i) a fan interposed between the work chamber and the filtration chamber for drawing air under negative pressure from the work chamber and delivering the air under positive pressure into the filtration chamber,
(ii) a filter between the filtration chamber and the work chamber for removing contaminants from the air before re-entering the work chamber, and
(iii) an air flow baffle disposed within the filtration chamber adjacent the fan for dividing the pressurized air delivered by the fan and partially redirecting a portion thereof for more uniformly delivering the air to the filter,
(iv) the baffle comprising a generally planar flange disposed at an obtuse angle to a leading end of the baffle facing the fan and oriented generally in parallel relation to the direction of pressurized air flow from the fan and a curvilinear main baffle body connected angularly to and extending away from the flange.

16. A biological safety cabinet according to claim 15, wherein the curvilinear main baffle body comprises a generally linear section connected angularly to the flange and a generally curved section extending reversely from the linear section.

17. A biological safety cabinet according to claim 16, wherein the curvilinear main baffle body comprises a second generally linear section extending from the generally curved section.

18. A biological safety cabinet according to claim 16, wherein the obtuse angle is between about 135 degrees and about 155 degrees.

19. A biological safety cabinet according to claim 18, wherein the obtuse angle is approximately 146 degrees.

20. A biological safety cabinet according to claim 15, further comprising a second filter between the filtration chamber and an exhaust opening in the housing for exhausting a portion of the pressurized air delivered by the fan to outside the housing.

21. A biological safety cabinet according to claim 20, further comprising a second air flow baffle disposed within a distal region of the filtration chamber at a spacing from the fan for supplemental direction of a portion of the pressurized air delivered by the fan into the distal region of the filtration chamber.

22. A biological safety cabinet according to claim 21, wherein the first-mentioned baffle and the second baffle cooperatively direct a portion of the pressurized air delivered by the fan to the first-mentioned filter and another portion of the pressurized air to the second filter.

23. A method of monitoring contamination loading of a filter in a biological safety cabinet comprising a housing defining a work chamber and a filtration chamber, and a filter between the filtration chamber and the work chamber, the method comprising the steps of
(a) circulating air between the work chamber and the filtration chamber by drawing air under negative pressure from the work chamber, delivering the air under positive pressure into the filtration chamber, and removing contaminants from the air by returning the air through the filter into the work chamber to capture the contaminants in the filter, and
(b) monitoring contamination loading of the filter by sensing negative air pressure entering the fan, sensing positive air pressure in the filtration chamber on the opposite side of the fan, determining a pressure differential between the sensed negative and positive pressure, and evaluating contamination loading of the filter in relation to the pressure differential.

24. A method of monitoring contamination loading of a filter in a biological safety cabinet according to claim 23, wherein the step of determining a pressure differential comprises producing an output voltage which varies according to the pressure differential.

25. A method of monitoring contamination loading of a filter in a biological safety cabinet according to claim 23, wherein the step of evaluating contamination loading of the filter includes computing a quantitative value representative of the contamination loading of the filter as a function of changes sensed in the pressure differential over a time period of use of the filter.

26. A method of monitoring contamination loading of a filter in a biological safety cabinet according to claim 23, further comprising controlling the air flow within the filtration chamber by dividing the pressurized air delivered by the fan and partially redirecting a portion thereof for more uniformly delivering the air to the filter.

27. A method of controlling and directing flow of contaminated air to a filter in a biological safety cabinet according to claim 26, further comprising the step of exhausting a portion of the pressurized air delivered by the fan into the filtration chamber through a second filter to outside the housing.

28. A method of controlling and directing flow of contaminated air to a filter in a biological safety cabinet according to claim 27, further comprising the step of supplementally directing a portion of the pressurized air delivered by the fan into a distal region of the filtration chamber at a spacing from the fan.

29. A method of controlling and directing flow of contaminated air to a filter in a biological safety cabinet according to claim 28, wherein the dividing and partial redirecting of the pressurized air delivered by the fan and the supplemental directing of a portion of the pressurized air in the distal region of the filtration chamber cooperatively direct a portion of the pressurized air delivered by the fan to the filter and exhaust another portion of the pressurized air to outside the housing.
